(19) United States
(12) Patent Application Publication
(10) Pub. No.: US 2026/0294088 A1
(43) Pub. Date: Oct. 1, 2026

(54) Portable Toothbrush

(71) Applicant: SKG ltalia S.P.A., Parma (IT)

(72) Inventor: Michele Bernini, Parma (IT)

(21) Appl. No.: 19/476,982

(22) PCT Filed: Jun. 21, 2024
(86) PCT No.: PCT/IB2024/056089

§ 371 Date: Oct. 20, 2025

(30) Foreign Application Priority Data
Jun. 22, 2023 (IT) 102023000012915

(51) Int. Cl. A46B 11/00; A46B 1/00; A46B 5/00; A46B 9/04; A46D 1/00; A61C 17/00

(52) U.S. Cl. CPC A46B 11/0003; A46B 1/00; A46B 5/00; A46B 9/045; A46D 1/0276; A61C 17/00; A46B 2200/1066

(57) ABSTRACT

A tooth cleaning device (1) is described, comprising a main body (2) at least partly compressible suitable for chewing and having an outer surface (20); a plurality of bristles (3) arranged on the outer surface (20) of the main body (2); the main body (2) has a mouth (21) defining an inner cavity (210) formed in the main body (2) and suitable for containing a cleaning and/or disinfectant substance; the main body (2) has two secondary openings (22) defining two channels (220) obtained in the main body (2); the channels (220) are fluid-dynamically connected to the inner cavity (210); the secondary openings (22) are arranged on opposite sides of said main body (2) to distribute said substance when the main body (2) is compressed during chewing.

The present invention relates to a tooth cleaning device.

The present invention finds useful employment in the field of oral hygiene, particularly for performing tooth cleaning in situations where the use of traditional methods is difficult, for example in the absence of water and/or toothpaste or, more generally, of a proper hygienic place. For example, the present invention allows a person traveling or, more generally, a person who spends several hours away from home, to perform tooth cleaning.

Various types of tooth cleaning devices are known.

In particular, tooth cleaning devices suitable for allowing oral hygiene in cases where it is not possible to use a traditional toothbrush are known.

For example, a tooth cleaning device is known that does not require water or toothpaste. Such device consists of a chewable disc-shaped body on which several rows of bristles are arranged at the edge, extending transversely to the disc-shaped body itself. The disc-shaped body is also covered with a layer of a cleaning and/or disinfectant substance containing fluoride and xylitol.

In particular, such device has small dimensions (1-3 cm) so that it can be placed in the mouth and passed between the teeth being moved by the tongue, removing any food residues present, due to the mechanical action exerted by the bristles on the teeth, and refreshing the mouth.

Such tooth cleaning device is portable and disposable.

In particular, unlike the traditional toothbrush, not having handles to hold, such tooth cleaning device can also be used by those who have difficulty in using their limbs.

However, the tooth cleaning obtained by such device is not optimal. For example, the layer of cleaning substance is quickly consumed, and therefore the sensation of freshness also runs easily out.

The object of the present invention is to overcome the above-mentioned drawbacks and, in particular, to ideate a tooth cleaning device that allows a thorough tooth cleaning.

A further object of the present invention is to provide a portable tooth cleaning device.

The mentioned objects, and others that will become more apparent later, are achieved by a tooth cleaning device as recited in independent claim 1.

Further features of the tooth cleaning device are provided in the dependent claims.

The features and advantages will be more apparent from the description of preferred, but not exclusive, embodiments of a tooth cleaning device, illustrated by way of example and not limitation with the help of the attached drawings in which:

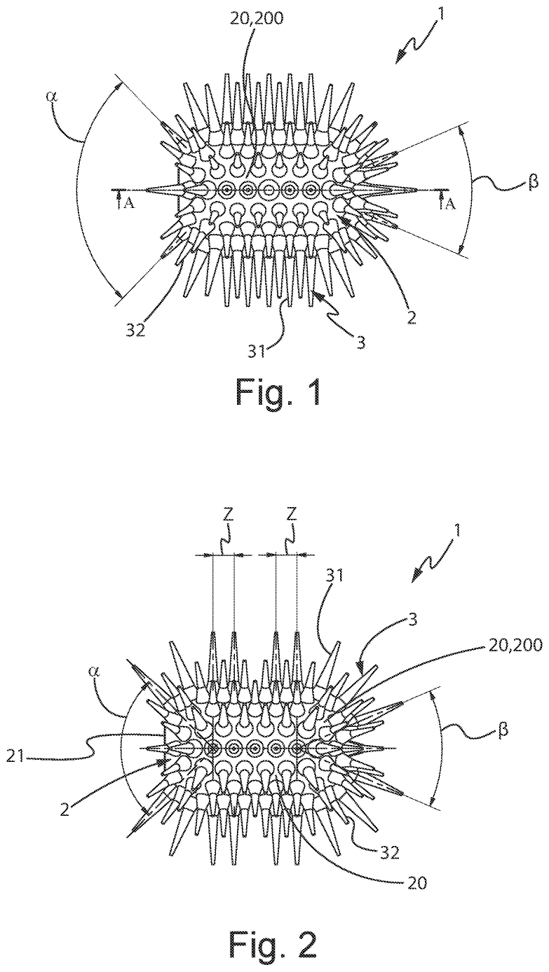

FIG. 1 shows a first side view of a tooth cleaning device according to the present invention;

FIG. 2 shows a second side view of the tooth cleaning device of FIG. 1;

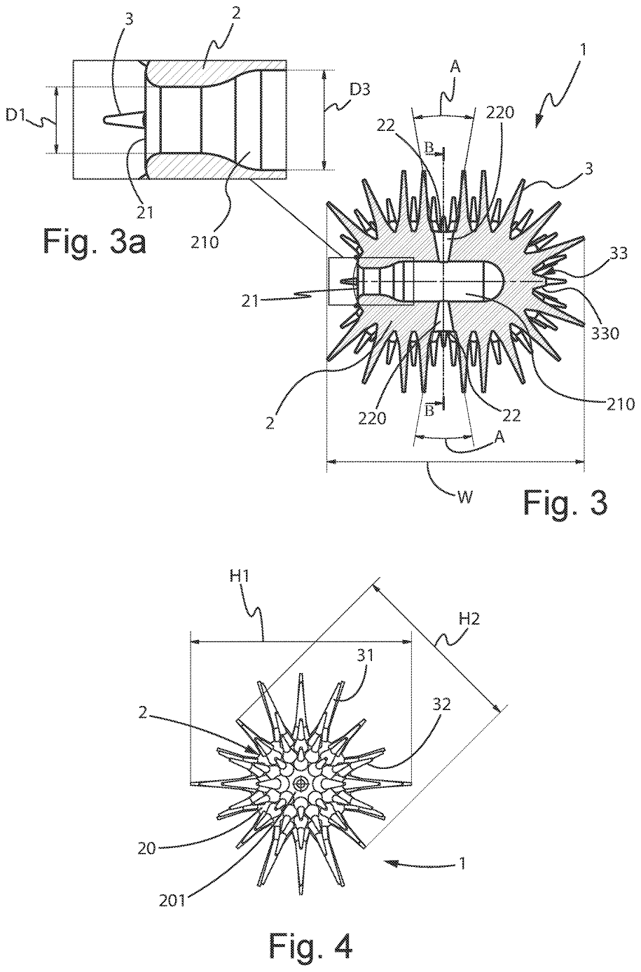

FIG. 3 shows a sectional view of the tooth cleaning device of FIG. 1, sectioned along the line A-A shown in FIG. 1;

FIG. 3a shows an enlargement of a portion of FIG. 3;

FIG. 4 shows a top view of the tooth cleaning device of FIGS. 1 and 2;

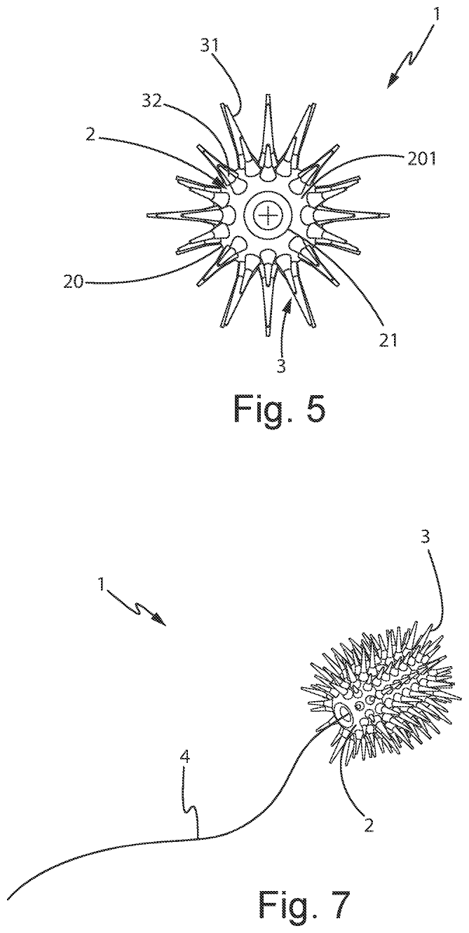

FIG. 5 shows a bottom view of the tooth cleaning device of FIGS. 1, 2, and 4;

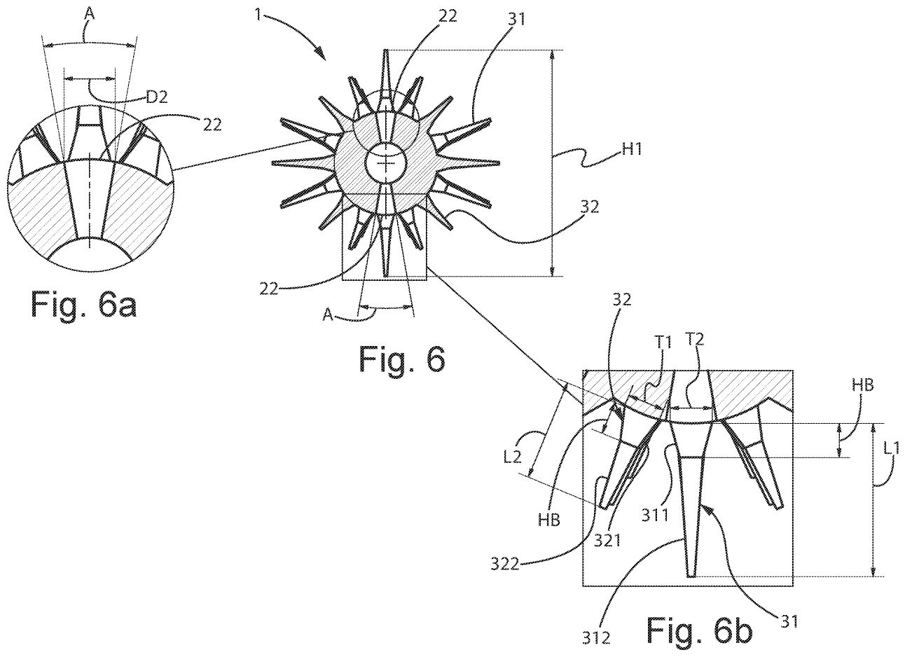

FIG. 6 shows a sectional view of the tooth cleaning device of FIGS. 1, 2, 4, and 5, sectioned along the line B-B depicted in FIG. 2;

FIGS. 6a and 6b show two respective enlargements of two different portions of FIG. 6;

FIG. 7 shows a perspective view of a tooth cleaning device according to a particular embodiment of the present invention;

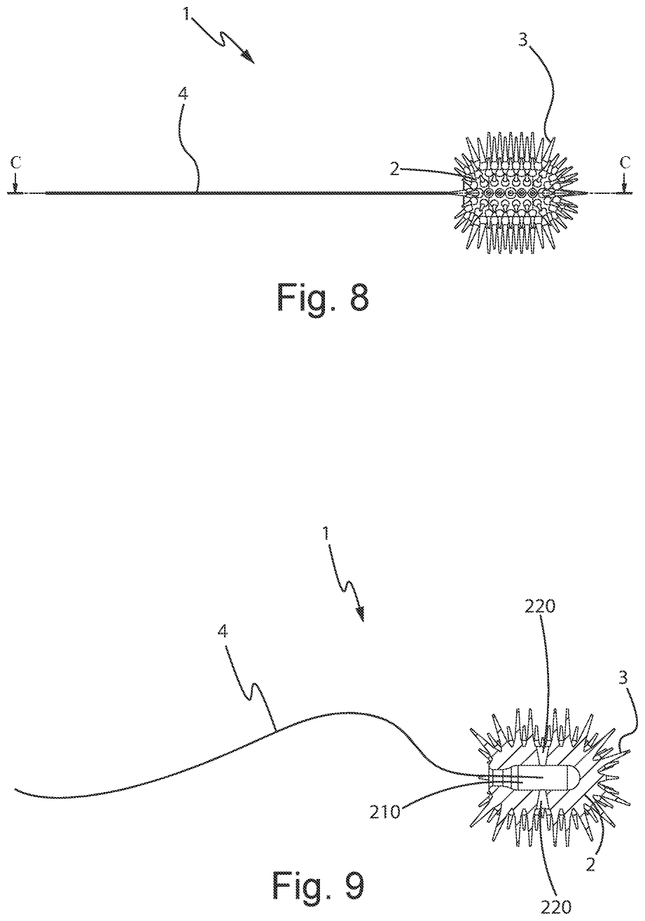

FIG. 8 shows a different perspective view of the device of FIG. 7;

FIG. 9 shows a section of the device of FIGS. 7 and 8 sectioned along the section line C-C indicated in FIG. 8.

With reference to FIGS. 1-9, a tooth cleaning device is described below, indicated by the reference number 1.

It should be noted that the tooth cleaning device 1 described below is a toothbrush that allows the oral cavity of a user to be cleaned by simply moving the same by the tongue inside the oral cavity.

As can be observed from the figures, the tooth cleaning device 1 is handle-free.

In accordance with the present invention, the tooth cleaning device 1 comprises a main body 2 that is at least partly compressible and suitable for chewing. The main body 2 is suitable for being placed in contact with the oral cavity of a user.

The main body 2 has an outer surface 20.

The tooth cleaning device 1 comprises a plurality of bristles 3.

In particular, the bristles 3 are arranged on the outer surface 20 of the main body 2.

The bristles 3 are also suitable for being placed in contact with the oral cavity of a user.

For example, the main body 2 and the bristles 3 are made of polymeric material or silicone.

Advantageously, the main body 2 and the bristles 3 are resistant to chewing but sufficiently soft not to damage the gums.

Preferably, the bristles 3 are made of the same material as the main body 2.

More details on the bristles 3 are provided in the following description.

The main body 2 has a mouth 21 that defines an inner cavity 210 formed in the main body 2. The inner cavity 210 is suitable for containing a cleaning and/or disinfectant substance.

The cleaning and/or disinfectant substance can be toothpaste, an emulsion, a mouthwash, and more.

For example, the cleaning and/or disinfectant substance can also contain PRG and/or bicarbonate. In particular, the latter, in contact with saliva, creates a “booster” effect that enhances the sensation of freshness and automatically salivation, useful for mixing the present components.

Preferably, the cleaning and/or disinfectant substance is a substance provided with a viscosity such that it remains contained in the inner cavity 210 before use.

In other words, the main body 2 comprises a reservoir, i.e., the inner cavity 210, which encloses such substance.

It should be noted that the inner cavity 210 can also contain two or more cleaning and/or disinfectant substances, even mixed together.

The main body 2 further has two secondary openings 22. The secondary openings 22 define two channels 220 obtained in the main body 2.

The channels 220 are fluid-dynamically connected to the inner cavity 210.

In particular, the secondary openings 22 are arranged on opposite sides of the main body 2 to distribute the substance when the main body 2 is compressed during use and thus chewing.

It should be noted that, due to the present invention, the distribution of the cleaning and/or disinfectant substance inside the oral cavity of the user during chewing is optimal, due to the presence not only of the mouth 21 but also of the secondary openings 22.

Indeed, positioning the mouth 21 and the secondary openings 22 allows the cleaning and/or disinfectant substance to be supplied simultaneously in various areas of the oral cavity of the user when the main body 2 is compressed.

It should also be noted that preferably the cleaning and/or disinfectant substance is inserted into the inner cavity 210 by injecting it through one or more dispensers between the mouth 21 and the secondary openings 22.

Therefore, due to the present invention, it is possible to simultaneously inject two or three different substances, injecting a first substance through the mouth 21 and one or two substances through the secondary openings 22.

Preferably, the main body 2 has a substantially cylindrical or elongated spherical or oval shape.

In other words, the outer surface 20 of the main body 2 can be divided into a side surface 200 and two base surfaces 201.

The main body 2 further has a rounded/chamfered shape so as to be easily movable by a user inside the mouth.

In particular, the secondary openings 22 are arranged on the side surface 200 of the main body 2 while the mouth 21 is arranged on a base surface 201 of the main body 2.

Preferably, the mouth 21 has a first dimension D1 and the secondary openings 22 have a second dimension D2 smaller than the first dimension D1.

Preferably, the mouth 21 has a circular shape.

Preferably, the secondary openings 22 also have a circular shape. In such case, the first dimension D1 and the second dimension D2 correspond to the diameters of the mouth 21 and the secondary openings 22, respectively.

Preferably, the inner cavity 210 has a substantially cylindrical or elongated spherical or oval or oblong shape.

Preferably, the inner cavity 210 has a third dimension D3 that is greater than the first dimension D1 of the mouth 21 and the second dimension D2 of the secondary openings 22.

The third dimension D3 is preferably the diameter of the inner cavity 210.

Advantageously, the cleaning and/or disinfectant substance remains contained within the inner cavity 210 without leaking when the main body 2 is not compressed.

Preferably, the channels 220 have a tapered shape. Still preferably, the channels 220 have a truncated cone shape.

Advantageously, such shape allows to facilitate the leakage of the cleaning and/or disinfectant substance during chewing of the tooth cleaning device 1.

Furthermore, such shape is particularly useful in the case where the tooth cleaning device 1 is made by molding, allowing the use of supports positioned inside the channels 220. Such supports are also useful for extracting the tooth cleaning device 1 through pistons positioned inside the mold that, after molding, allow to push the tooth cleaning device 1 out of the mold. Such pistons are activated automatically during the opening of the mold.

Indeed, the main body 2 and the bristles 3 are preferably made by injection molding.

Alternatively, the main body 2 and the bristles 3 can be made by 3D printing. Or the bristles 3 can be inserted in the main body 2 through known processes as in current tooth cleaning devices, i.e., by pressure, but it is clear that in such case, the main body 2 of the tooth cleaning device 1 must be specially conformed so as to house the bristles 3.

Preferably, the tooth cleaning device 1 is made in one piece of a single material.

Preferably, the bristles 3 are made on the entire outer surface 20 of the main body 2.

In other words, the bristles 3 are not only arranged on some portions of the main body 2 but the outer surface 20 of the main body 2 is uniformly covered by the bristles 3, except for the portion of the base surface 201 surrounding the mouth 21. Advantageously, the bristles 3 work in all directions, thereby allowing a thorough cleaning of the entire oral cavity, of both the teeth and tongue of the user.

Preferably, the plurality of bristles 3 comprises first bristles 31 having a first length L1 and second bristles 32 having a second length L2 less than the first length L1.

Preferably, the first bristles 31 are arranged in rows in the axial direction of the main body 2. Preferably, the second bristles 32 are also arranged in rows in the axial direction of the main body 2.

The first bristles 31, i.e., the longer ones, are softer due to their geometry. Instead, the second bristles 32, i.e., the shorter ones, are stiffer due to their geometry. In particular, when the tooth cleaning device 1 is placed in the oral cavity of a user, when the first bristles 31 come into contact with the teeth, they bend and thus come into contact with the teeth from multiple angles, also allowing the second bristles 32 to act. In other words, the second bristles 32 come into contact with the teeth as the first bristles 31 bend.

Preferably, the bristles 3 have a composite geometry.

Preferably, the bristles 3 comprise a base 311, 321 and a tip 312, 322 seamlessly connected to the base 311, 321. In particular, both the first bristles 31 and the second bristles 32 comprise a respective base 311, 321 and a respective tip 312, 322.

With particular reference to FIG. 6b, the base 311, 321 preferably has a truncated cone shape. The tip 312, 322 has a truncated cone or substantially cone shape and extends away from the base 311, 321.

In other words, preferably the bristles 3 comprise a first truncated cone part, i.e., the base 311, 321, on which a second truncated cone or cone part, i.e., the tip 312, 322, is superimposed. The tip 312, 322 of each bristle 3 has the same dimensions at the bottom as the upper end of the respective base 311, 321 from which such tip 312, 322 extends.

Preferably, the base 311 of the first bristles 31 is made with a first truncated cone shape while the tip 312 of the first bristles 31 is made with a second truncated cone shape superimposed on the first truncated cone shape.

Still preferably, the base 321 of the second bristles 32 is made with a third truncated cone shape while the tip 322 of the second bristles 32 is made with a fourth truncated cone shape superimposed on the third truncated cone shape.

Therefore, the first bristles 31 and the second bristles 32 have a double geometry.

This geometry allows to have a thicker, i.e., stiffer, base 311, 321, and at the same time a thinner and more flexible tip 312, 322. In particular, the stiffer base 311, 321 gives the respective first bristles 31 and second bristles 32 a greater resistance both during chewing and during the injection molding of the tooth cleaning device 1, allowing an easy removal of the piece from the mold without breaking the bristles 3. Instead, the thinner tips 312, 322 allow to obtain a good tooth cleaning, being able to fit into the spaces between the teeth, and at the same time remaining comfortable for the user due to their flexibility. Furthermore, such particular shape of the bristles 3 allows to obtain a greater separation between adjacent bristles 3, which promotes a good cooling of the object when extracted from the mold.

Preferably, the bases 311 of the first bristles 31 have a diameter T1, and the bases 321 of the second bristles 32 have a diameter T2 smaller than the diameter T1 of the first bristles 31. Preferably, the bases 311, 321 of the first and second bristles 31, 32 instead have the same height HB.

Preferably, in the case where the tooth cleaning device 1 is injection-molded, the bristles 3 also comprise a third bristle 33 arranged on the base surface 201 opposite to the mouth 21. The third bristle 33, particularly visible in FIG. 3, is composed solely of a base 331 that is similar to the bases 311, 321 of the first and second bristles 31, 32. In other words, the third bristle 33 does not have a tip because it is the injection point, i.e., the point where the material, for example, the polymer, in the liquid state, penetrates into the mold, thus filling the mold cavity to make the tooth cleaning device 1.

Preferably, the tooth cleaning device 1 has an outer width W between 10 and 30 mm and an outer height H1 between 10 and 30 mm. The outer height H1 is preferably less than the first outer dimension W.

The outer width W is particularly intended as the maximum width of the tooth cleaning device 1 including both the dimensions of the main body 2 and the bristles 3, as particularly visible in FIG. 3. In particular, the outer width W corresponds to the width of the tooth cleaning device 1 at the first bristles 31.

Similarly, the outer height H1 is intended as the maximum height of the tooth cleaning device 1 including both the dimensions of the main body 2 and the bristles 3, as particularly visible in FIG. 3. In particular, the outer height H1 corresponds to the height of the tooth cleaning device 1 at the first bristles 31.

The tooth cleaning device 1 also has a further outer height H2 between 10 and 30 mm, which is less than the outer width W and also less than the outer height H1.

In particular, the further outer height H2 corresponds to the height of the tooth cleaning device 1 at the second bristles 32.

More preferably, the tooth cleaning device 1 has dimensions such that if accidentally ingested, it does not cause choking, having dimensions smaller than those of the oesophagus diameter of a 7-year-old child.

Preferably, the outer width W is between 15 and 24 mm. For example, the outer width W is between 18 and 19 mm.

Preferably, the outer height H1 is between 12 and 21 mm. For example, the outer height H1 is between 16 and 17 mm.

Preferably, the further outer height H2 is between 10 and 17 mm. For example, the further outer height He is between 13 and 14 mm.

Preferably, the above-mentioned first dimension D1 is between 1 and 3 mm. For example, the first dimension D1 is 2 mm.

Still preferably, the above-mentioned second dimension D2 is between 1 and 2 mm. For example, the second dimension D2 is 1.5 mm.

Preferably, the above-mentioned third dimension D3 is between 1 and 5 mm. For example, the third dimension D3 is 3 mm.

Preferably, the main body 2 has a thickness S between 1 and 3 mm. For example, the thickness S is 1.5 mm.

Preferably, the inner cavity 210 has a volume between 0.05 and 0.8 cc. More preferably, the inner cavity has a volume of 0.1 cc.

Preferably, the channels 220 have an amplitude A between 10° and 30°, more preferably between 15° and 25°. For example, the amplitude A is 20°.

Preferably, the above-mentioned first length L1 is between 1 and 3 mm. For example, the first length L1 is 2 mm.

Preferably, the above-mentioned second length L2 is between 1 and 5 mm. For example, the second length L2 is 3 mm.

Preferably, the above-mentioned diameter T1 of the bases 311 of the first bristles 31 is between 0.9 mm and 1.5 mm. For example, the diameter T1 of the bases 311 of the first bristles 31 is 1.2 mm.

Preferably, the above-mentioned diameter T2 of the bases 321 of the second bristles 32 is between 0.8 mm and 1.4 mm. For example, the diameter T2 of the bases 321 of the second bristles 32 is 1.1 mm.

Preferably, the above-mentioned height HB of the bases 311, 321 of the first and second bristles 31, 32 is between 0.5 and 1.5 mm. For example, the height HB of the bases 311, 321 of the first and second bristles 31, 32 is 1 mm.

Preferably, the centres of the bases 311, 321 of two adjacent bristles 3 on the side surface 200 are spaced by a distance Z between 1 and 2 mm. For example, the distance Z is 1.5 mm.

Preferably, two first bristles 31 or two second bristles 32 opposite to each other and placed on the base surface 201 on the mouth side 21 make a circular arc that subtends an angle a between 80° and 110°, as shown in FIGS. 1 and 2. For example, the angle a is 92°.

Preferably, two first bristles 31 or two second bristles 32 opposite to each other and placed on the base surface 201 on the side opposite to the mouth 21 make a circular arc that subtends an angle β between 40° and 60°, as shown in FIGS. 1 and 2. For example, the angle β is 47°.

The tooth cleaning device 1 described is portable.

In particular, the tooth cleaning device 1 has small dimensions (1-3 cm) so that it can be placed in the mouth by a user and passed between the teeth being moved by the tongue, removing any food residues present, due to the mechanical action exerted by the first bristles 31 and the second bristles 32 on the teeth, and refreshing the mouth, regardless of where the user is.

Preferably, the tooth cleaning device 1 comprises a coating layer (not visible in the attached figures) that is applied to the main body 2 on the outer surface 20 and/or in the inner cavity 210 and on the bristles 3.

In other words, the coating layer is a layer placed to cover the main body 2 and the bristles 3, which is applied to the main body 2 and/or the bristles 3.

The coating layer is ingestible. Preferably, the coating layer comprises encapsulated micro-particles that are decomposed upon contact with saliva or through mechanical pressure.

This causes the materials enclosed in these micro-particles to remain protected from external agents, such as for example the oxygen present in the air, which would cause first an oxidation of the aroma and then a potential loss of effectiveness, ensuring a much longer-lasting external coating.

The coating layer is, for example, a substance that protects/repairs the teeth, such as PRG or toothpaste, mouthwash, or more.

According to a particular embodiment of the present invention, the tooth cleaning device 1 comprises a wire 4. The wire 4 is at least partially inserted into and connected to the inner cavity 210.

In the case of an injection-molded main body 2, the main body 2 is molded directly onto the wire 4 to connect the wire 4 to the main body 2. Advantageously, the wire 4 remains trapped between the material of the main body 2 and therefore is connected thereto.

Alternatively, the wire 4 can also be knotted to the main body 2 at a specific point of the inner cavity 210.

The wire 4 can be a safety tool, particularly for disabled people, or in general to prevent an accidental ingestion of the tooth cleaning device 1.

Furthermore, preferably the wire 4 is a dental floss made of nylon or other biodegradable materials, such as PLA (polylactic acid) derived from corn starch, or bamboo or silk fiber.

Preferably, the tooth cleaning device 1 is single-use.

Preferably, the main body 2 and the bristles 3 are made of a recyclable or biodegradable material, for example, like those described above for the wire 4.

Alternatively, the main body 2 and the bristles 3 are configured to be dissolved little by little with chewing and/or contact with saliva, until they are completely liquefied and ingested.

The tooth cleaning device 1 described, when coming into contact with the various surfaces of the oral cavity, removes the dental plaque and also the bacteria present on the tongue, without needing water and/or toothpaste and especially without the use of hands, as the cleaning action is obtained through the tongue movement, chewing, and mandibular movement.

Advantageously, the tooth cleaning device 1 according to the present invention allows to clean hard-to-reach areas (e.g., lingual or palatal surface of the upper and lower incisors).

Advantageously, the tooth cleaning device 1 according to the present invention also allows people with difficulty in using their upper limbs to brush their teeth independently.

Advantageously, on the outer part of the tooth cleaning device, a coating a few microns thick with micro-encapsulated particles and imperceptible to the human eye is applied, which serves to make the use of the tooth cleaning device more pleasant as it is flavoured, but at the same time active agents for oral hygiene protection and prevention can be used.

Advantageously, the tooth cleaning device has several bristles of various lengths and as many directions that enhance the cleaning performance.

Advantageously, to complete the cleaning of the oral cavity, a dental floss can be integrated to also improve the cleaning between the teeth, which is difficult to achieve with traditional brushing.

The tooth cleaning device thus conceived is susceptible of a number of modifications and variations, all falling within the scope of the inventive concept; furthermore, all details can be replaced by technically equivalent elements. In practice, the materials used, as long as compatible with the specific use, as well as the contingent dimensions and shapes, can be any according to technical requirements.

What is claimed:

1-12. (canceled)

13. Tooth cleaning device, comprising:
a main body at least partly compressible suitable for chewing and having an outer surface;
a plurality of bristles arranged on the outer surface of the main body;
the main body having a mouth defining an inner cavity formed in the main body and suitable for containing a cleaning and/or disinfectant substance;
the main body having two secondary openings defining two channels obtained in the main body;
the channels being fluid-dynamically connected to the inner cavity; and
the secondary openings being arranged on opposite sides of the main body to distribute the substance when the main body is compressed during chewing.

14. Tooth cleaning device according to claim 13, wherein the mouth has a first dimension (D1) and the secondary openings have a second dimension (D2) smaller than said first dimension (D1).

15. Tooth cleaning device according to claim 13, wherein the channels have a tapered shape.

16. Tooth cleaning device according to claim 13, wherein the channels have a truncated cone shape.

17. Tooth cleaning device according to claim 13, wherein the plurality of bristles are made on the entire outer surface of the main body.

18. Tooth cleaning device according to claim 13, wherein the plurality of bristles comprises first bristles having a first length (L1) and second bristles having a second length (L2) less than the first length (L1).

19. Tooth cleaning device according to claim 13, having an outer width (W) between 10 and 30 mm and an outer height (H1) between 10 and 30 mm and less than the first outer dimension (W).

20. Tooth cleaning device according to claim 13, comprising a coating layer applied to the main body on the outer surface and/or in the inner cavity and on the bristles.

21. Tooth cleaning device according to claim 13, comprising a wire at least partially inserted into and connected to the inner cavity.

22. Tooth cleaning device according to claim 21, wherein the main body and the plurality of bristles are made by injection molding, the main body being molded onto the wire to connect the wire to the main body.

23. Tooth cleaning device according to claim 13, wherein each bristle of the plurality of bristles comprises a base and a tip seamlessly connected to the base; the base having a truncated cone shape and the tip having a truncated cone or substantially cone shape and extending away from the base.

24. Tooth cleaning device according to claim 23, wherein the tip of each bristle of the plurality of bristles has the same dimensions at the bottom as the upper end of the respective base from which the tip extends.
